(19) United States
(12) Patent Application Publication
(10) Pub. No.: US 2017/0269004 A1
(43) Pub. Date: Sep. 21, 2017

(54) LOW IMPURITY DETECTION METHOD FOR CHARACTERIZING METALS WITHIN A SURFACE AND SUB-SURFACE OF POLYCRYSTALLINE SILICON

(71) Applicant: Hemlock Semiconductor Corporation, Hemlock, MI (US)

(72) Inventors: Adam Fournier, Midland, MI (US); Douglas Kreszowski, Saginaw, MI (US); Carl Puehl, III, Midland, MI (US)

(21) Appl. No.: 15/074,091

(22) Filed: Mar. 18, 2016

(51) Int. Cl. G01N 21/94; G01N 27/62; G01N 30/86; G01N 21/73

(52) U.S. Cl. CPC G01N 21/94; G01N 21/73; G01N 27/626; G01N 30/8675

(57) ABSTRACT

A method of quantifying metal impurities on a silicon product, includes obtaining a sample of the silicon product; etching or chemically treating a surface of silicon product to retrieve a predetermined amount of silicon product mass; and testing and measuring the etched portion for the presence of metal impurities using a testing measurement technique selected from ICP-MS, ICP-OES, IC, or a combination comprising at least one for the foregoing, wherein the metal impurities are selected from sodium, magnesium, nickel, copper, zinc, molybdenum, tungsten, aluminum, potassium, calcium, titanium, chromium, manganese, iron, cobalt, or a combination comprising at least one of the foregoing.

### TECHNICAL FIELD

Disclosed herein is a method of quantifying metal impurities on a silicon product.

### BACKGROUND

The electronics industry requires extremely high performance demands. This means that semiconductor materials with extremely high purity are required. Analytical techniques are needed to characterize extremely low levels (i.e., parts per trillion atomic (ppta)) of trace metals in semiconductor materials. For example, trace metal analysis for semiconductor grade silicon at low levels can be accomplished with inductively coupled mass spectrometry (ICP-MS), high resolution inductively coupled mass spectrometry (HR-ICP-MS), glow discharge mass spectrometry (GDMS), neutron activation analysis, as well as atomic absorption spectrometry.

One of the more sensitive analytical techniques is neutron activation analysis. This technique is described in several references, including: Martin, Semiconductor Silicon, Ed. by R. R. Haberecht, p. 547 (1969); Heinen et al., Anal. Chem., 38 (13), p. 1853 (1966); and Thompson et al., Anal. Chem., 30(6), p. 1023 (1958). While this technique is sensitive, a large neutron-generating radiation source is necessary. Additionally, several weeks can be required to complete the monitoring of the radioactive decay of the nucleides generated. Thus, this technique is both expensive and time-consuming.

Atomic absorption has largely been replaced by ICPMS technology as a trace elemental method. Recent examples of trace metals analysis via ICPMS are Sohrin, et al., Analytical Chemistry, p. 6267-73 (2008); Su, et al., Analytical Chemistry, p. 6959-67 (2008); Campbell et al., Analytical Chemistry, p. 939-46 (1999) show routine analyses of metallic species at ppt levels.

A float-zone refining technique can be used to significantly concentrate trace metal impurities, which can then be tested and processed by various trace metal analytical techniques to reliably define levels of the trace metal impurities present in the samples.

A flowable recharge silicon (FRS) test described in WO2015/103366 A1 can be used to capture certain impurities, present in semiconductor grade silicon samples.

Despite the metal impurity measurement capabilities of the above techniques, there is still a need for a test and method that can reliably determine and test the amount of various impurities present in a wider size range of semiconductor grade silicon samples.

### SUMMARY

A method of quantifying metal impurities on a silicon product, comprises: obtaining a sample of the silicon product; etching or chemically treating a surface of silicon product to retrieve a predetermined amount of silicon product mass; and testing and measuring the etched portion for the presence of metal impurities using a testing measurement technique selected from ICP-MS, ICP-OES, IC, or a combination comprising at least one of the foregoing, wherein the metal impurities are selected from sodium, magnesium, nickel, copper, zinc, molybdenum, tungsten, aluminum, potassium, calcium, titanium, chromium, manganese, iron, cobalt, or a combination comprising at least one of the foregoing.

A method of quantifying metal impurities on silicon products, comprises: obtaining a sample of a silicon product; removing 1.0% to 2.0% sample mass of the silicon product to obtain an etched portion of the silicon product; and testing and measuring the etched portion for the presence of metal impurities using a testing measurement technique selected from ICP-MS, ICP-OES, IC, or a combination comprising at least one of the foregoing, wherein the metal impurities are selected from sodium, magnesium, nickel, copper, zinc, molybdenum, tungsten, aluminum, potassium, calcium, titanium, chromium, manganese, iron, cobalt, or a combination comprising at least one of the foregoing.

### BRIEF DESCRIPTION OF THE DRAWINGS

The following is a brief description of the drawings wherein like elements are numbered alike and which are exemplary of the various embodiments described herein.

FIG. 1 is a graphical illustration of a copper profile.

FIG. 2 is a copper recovery profile for small (1), medium (2), and large (3) size silicon product material.

FIG. 3 is a graphical illustration of different consumption profiles for small (1), medium (2), and large (3) silicon product material.

FIG. 4 is a graphical representation of tungsten carbide consumption via the method disclosed herein.

FIG. 5 is a graphical representation of the maximum amount of measurable tungsten carbide.

### DETAILED DESCRIPTION

Polycrystalline silicon can be used as a raw material for the electronic industry as wafers or the solar industry as a part of photovoltaic modules. High purity of the raw material is required in both the electronic industry and in the solar industry. During production of polycrystalline silicon, polycrystalline silicon rods that are formed are broken into smaller pieces for further processing. During the breakage, the polycrystalline silicon can be contaminated by material from the breaking tools used to break the polycrystalline silicon rods and also from silicon dust particles that can adhere to the broken pieces of polycrystalline silicon. Additionally, a washing process of the polycrystalline silicon after it has been broken into pieces can impart impurities into the polycrystalline silicon. Impurities in the polycrystalline silicon can be troublesome in downstream products or processes in which the polycrystalline silicon is to be used. It can be useful to know the nature of the impurities present on the polycrystalline silicon surface to ensure that subsequent washing processes can be formulated to remove as many impurities as possible.

Disclosed herein is a method for quantifying metal impurities on a silicon product (e.g., a polycrystalline silicon product). The method can include obtaining a sample of a silicon product and etching or chemically treating a surface of the silicon product to retrieve a predetermined amount of silicon product mass. After retrieval, the silicon product mass can be tested for the presence of metal impurities. The testing and measuring can be accomplished with a technique such as, inductively coupled plasma mass spectrometry (ICP-MS), inductively coupled plasma atomic emission spectroscopy (ICP-OES), Ion Chromatography (IC), or a combination comprising at least one of the foregoing. The metal impurities to be tested for can include, but are not limited to, sodium, magnesium, nickel, copper, zinc, molybdenum, tungsten, aluminum, potassium, calcium, titanium, chromium, manganese, iron, cobalt, or a combination comprising at least one of the foregoing. It is to be understood that any metal which is capable of dissolving within acidic media can be tested using the method disclosed herein.

Etching a surface of the silicon product can include removing 0.5% to 5% sample mass of the silicon product to obtain an etched portion of the silicon product, for example, removing 0.6% to 3%, for example, removing 0.75% to 2.0%, for example, 1.0% to 1.5%.

The silicon product can comprise a polycrystalline silicon product comprising silicon particles having a size of 0.05 millimeters (mm) on a side to 500 mm on a side, for example, 0.1 mm to 250 mm, for example, 0.2 mm to 125 mm, for example, 0.5 mm to 75 mm.

The silicon product can have any geometric shape. For example, the silicon product can have a geometric shape selected from cube, cuboid, cylinder, sphere, triangular prism, cone, hexagonal prism, pentagonal prism, square pyramid, triangular pyramid, hexagonal pyramid, parallelepiped, tetrahedron, octahedron, dodecahedron, icosahedron, rhombic dodecahedron, frustum, or a combination comprising at least one of the foregoing.

The method can further include monitoring diffusion of metals from the surface of the silicon product into a sub-surface of the silicon product within 72 hours of exposing the metal impurities on the silicon product. Metal diffusion occurring within 72 hours is captured by the method disclosed herein. Reporting of the metal impurities values can be accomplished as a total metal impurity content for the silicon product. Reporting can include reporting bulk metal impurity measurements. The method can include comprising reporting metal impurity values as surface metals impurity values and bulk metal impurity values. A measurement technique such as NAA, GDMS, bulk metals tip process with trace metals analysis, or a combination comprising at least one of the foregoing can be used to report the surface metal impurity values and bulk metal impurity values. The measurement technique can allow for measurement and analysis of silicon product samples having varying product types, sizes, and geometric shapes.

Measuring of the total metal impurities can include measuring the amount of impurities from 1 part metal impurities per trillion atoms of silicon to 10,000 parts metal impurities per billion atoms of silicon, for example, 0.5 part metal impurities per billion atoms of silicon to 5,000 parts metal impurities per billion atoms of silicon, for example, 1 part metal impurities per billion atoms of silicon to 1,000 parts metal impurities per billion atoms of silicon.

The silicon product can have a weight of greater than or equal to 1 gram, for example, greater than or equal to 1.5 grams, for example, greater than or equal to 2 grams, for example, greater than or equal to 2.5 grams, for example, greater than or equal to 5 grams, for example, greater than or equal to 10 grams. For example, the silicon product can have a weight of 1 gram to 10 grams, for example, 1.5 grams to 5 grams, for example, 1.8 grams to 2 grams. The etching process can last for greater than or equal to 6 minutes, for example, greater than or equal to 6.5 minutes, for example, greater than or equal to 7 minutes, for example, greater than or equal to 10 minutes. For example, the etching can last for 6 minutes to 20 minutes, for example, 7 minutes to 15 minutes, for example, 8 minutes to 10 minutes.

Contaminants such as copper can result from equipment failures downstream. These contaminants, if not removed, can produce material out of specification (e.g., less than 0.015 parts per billion atomic (ppba) copper), and can cause yield problems. U.S. Pat. No. 2,657,114, George Wagner, detailed the effect of metal ions in solution, including copper, that undergoes galvanic plating onto silicon in the presence of trace HF according to the following equation at room temperature;

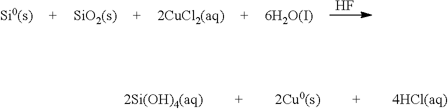

This reduction equation is not unique to copper and also happens with other metal salts (e.g., nickel and zinc) that are lower than silicon in the electromotive series. Metal contaminants in solution with lower electromotive force plate on a silicon surface when the metallic cation is in the presence of silicon and HF.

Previous test methods testing for the presence of copper (i.e., Vapor Phase Deposition (VPD) and Flowable Recharge Silicon (FRS)) were found to be ineffective at capturing the full magnitude of copper contamination on the silicon products. The limited acidity of the VPD process as practiced results in an ineffective re-suspension of surface metals critical to the testing process (copper, nickel, and zinc). Therefore, once the metals are plated onto the silicon in outside processes (such as finishing), the VPD test is unable to effectively remove metals.

Neither the VPD nor the FRS test is designed to measure copper deep enough into the silicon sub-surface to address issues with surface copper penetration into the bulk of a silicon product. Copper is known to migrate into silicon over time, along with some temperature dependence, as seen in Table 1¹:

TABLE 1
Copper Migration Depths (in micrometers) in Silicon as a Function of Time

| Temperature | 1 hour | 1 day | 1 week | 1 month | 2 months | 6 months | 1 year |
|---|---|---|---|---|---|---|---|
| 0° C. | 4 | 22 | 57 | 119 | 168 | 291 | 414 |
| 20° C. | 8 | 40 | 107 | 221 | 313 | 542 | 772 |
| 40° C. | 14 | 70 | 184 | 381 | 539 | 934 | 1330 |

### ¹. Askill, J. CRC Handbook of Chemistry and Physics Lide, D. R. Ed.; CRC Press 1990 pp 12-64 to 12-65.

The method disclosed herein includes a surface metals (e.g., copper, tungsten, etc.) method that etches deep enough into the surface of the silicon product to capture any incidental metal contamination that penetrates within a reasonable residual time period. Based on Table 1, it can be extrapolated that after 72 hours surface copper could penetrate between 70 to 120 micrometers dependent upon the silicon temperature where the temperature varied from 0° C. to 20° C.

The reasonable time period can be selected to reflect a normal time between final lot cleaning of the silicon product and final lot testing of the silicon product. The reasonable time period can be, for example, 72 hours. Silicon product sizes can include small chip material having a size of 0.2 to 18 mm, mid-size chunks of silicon product having a size of 12 to 65 mm, and larger chunks of silicon product having a size of 25-125 mm.

With the method disclosed herein it was discovered that metal impurities can be removed from the surface of the silicon product after greater than or equal to 6 minutes of cumulative etch time, for example, greater than or equal to 7 minutes, for example, greater than or equal to 8 minutes, for example, greater than or equal to 9 minutes. During etching, greater than or equal to 1.3% of the silicon product can be removed. For example, it can be desirable during etching to remove 1.0% to 2.0% of silicon mass.

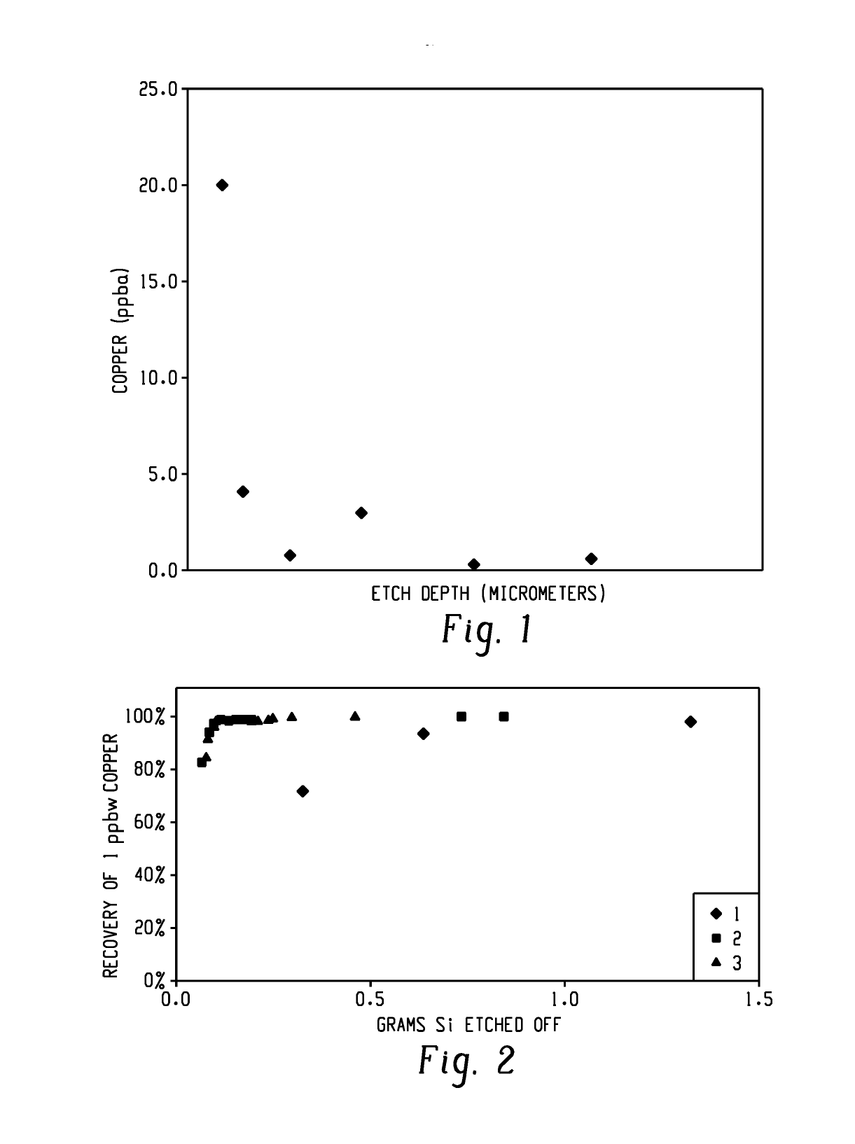

Actual impurity profiles of metals in silicon can illustrate that the surface contamination due to the presence of these metals can migrate approximately 50 to 90 μm in depth. Although these results differ than the predictions in Table 1, they are reasonable if it is assumed that migration in the medium sized silicon product can be retarded by formation of silicon oxides on the silicon surface. FIG. 1 demonstrates a copper profile where the amount of copper measured in parts per billion atomic (ppba) is plotted against the etch depth measured in micrometers.

FIG. 1 demonstrates that after etching of about 1.5 g of silicon, 100% recovery levels were reached for even the most segregated impurities (e.g., copper).

By targeting an empirical mass consumption of 1.5 grams on a 100 gram sample of silicon, different theoretical etch depths can be estimated for different silicon product lines, e.g., small, medium, and large as described herein with each sample assuming a cubic shape. At a fixed mass consumption since HF limits the mass loss of silicon, and assumed average size for each product type the etch depths can vary significantly between these three product lines as illustrated in Table 2. Initial silicon mass and mass consumed were measured in grams (g), initial radius was measured in centimeters (cm), and tech depth was measured in micrometers (μm).

TABLE 2
Etch depth Variance with Product Size

| | | #Pieces | #Pieces | #Pieces |
|---|---|---|---|---|
| | | Small Sur- | Medium Sur- | Large Sur- |
| Etch Method Data Entry | | face Area | face Area | face Area |
| Initial silicon mass (g) | 100 | 3 | 5 | 272 |
| Initial silicon volume (cm³) | | 14.31 | 8.59 | 0.158 |
| Initial radius (cm) with | | 2.43 | 2.05 | 0.540 |
| cube assumption | | | | |
| Etch Depth (μm) | | 122.0 | 102.9 | 27.2 |
| Mass consumed (g) | 1.5 | | | |

Since depth cannot be accurately determined, short of independently measuring geometry for each silicon piece, pieces which routinely assume a variety of shapes within each product line, the effectiveness of surface impurity recovery can be accomplished by measuring the mass of silicon removed by etching. To validate etching to a specific mass loss, a study was undertaken by uniform doping of different product lines. Specifically, 100 gram samples of high (large) surface area, medium surface area, and low (small) surface area silicon product lines were all doped to either 0.25, 1, or 10 parts per billion weight (ppbw) with a standard dopant comprising Fe, Ni, Cu, Cr, Na, Zn, K, Mg, Mn, Mo Ti, W, Zn, Co, W, or a combination comprising at least one of the foregoing. The dopant resided for 72 hours on the silicon and recovery studies were performed. An example is shown in FIG. 2 plotting dopant recovery versus grams silicon etched off 100 gram initial sample. Dopant recovery is measured in ppbw copper. An example of different consumption profiles for small 1, medium 2, and large 3 silicon product material is shown in FIG. 2, where small refers to a size of 0.2 to 18 mm, medium refers to a size of 12 to 65 mm, and large refers to a size of 25-125 mm.

It was discovered that to generate greater than 95% recovery for metal impurities of all surface area geometries between 0.2-18 mm to 25-125 mm is to ensure that greater than 1.0 grams silicon is etched off per 100 grams of silicon sample regardless of sample type (e.g., geometry). FIG. 2 demonstrates such a procedure will reliably ensure total surface metal impurity recovery for all fathomable conditions within the first 72 hours of surface contamination.

Optimization of the etch mixture (e.g., silicon digestion recipe) to target digestion of approximately 1.5 grams of silicon was based on the following stoichiometry:

SiO₂(s)+6HF(aq)→H₂SiF₆(g)+2H₂O(l)

Si(s)+4HNO₃(aq)→SiO₂(s)+4NO₂(g)+2H₂O(l)

The calculations were performed based on targeting etch consumption of approximately 1.5 grams of silicon per 100 gram sample, and round-off to easily applied volumes for HNO₃, HF, and HCl.

It can be desired to have the hydrofluoric acid as the limiting reagent so as to stop the reaction after the desired amount of silicon is removed. An excess of nitric acid (about 2:1 molar excess) can be built in to ensure any metal impurities stay soluble. Also, a small volume of hydrochloric acid can be added to help dissolve the tungsten carbide. The end result was an etching mixture of 25 ml of 70% HNO₃, 10 ml of 49% HF, 1 ml of 37% HCl and 64 ml distilled water H₂O per 100 grams of silicon.

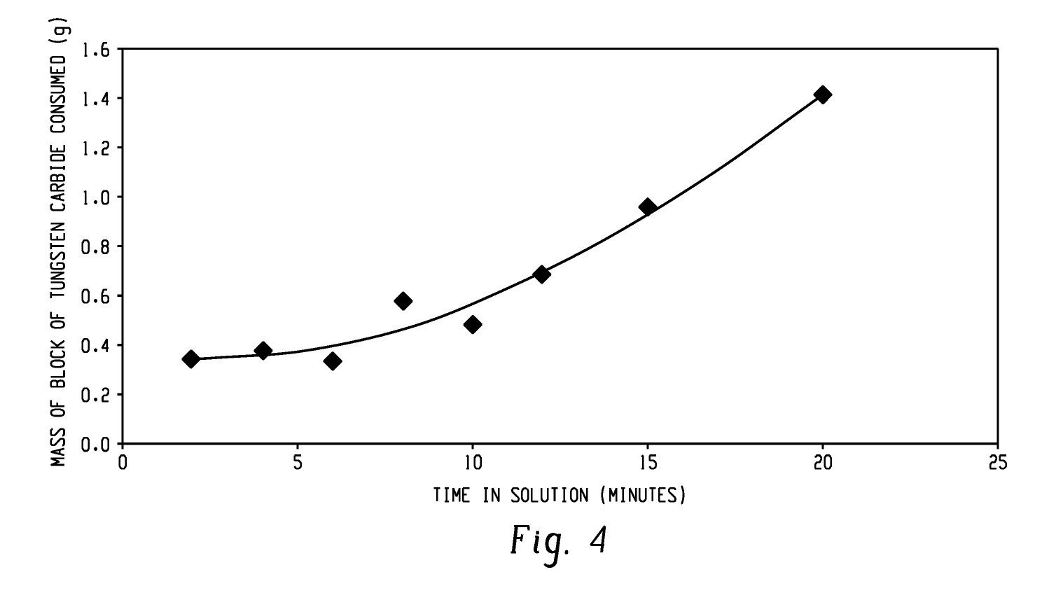

The method disclosed herein can also be applicable for dissolution of tungsten carbide as illustrated in FIG. 4 where the mass of a block of tungsten carbide consumed (g) is plotted against time in solution measured in minutes.

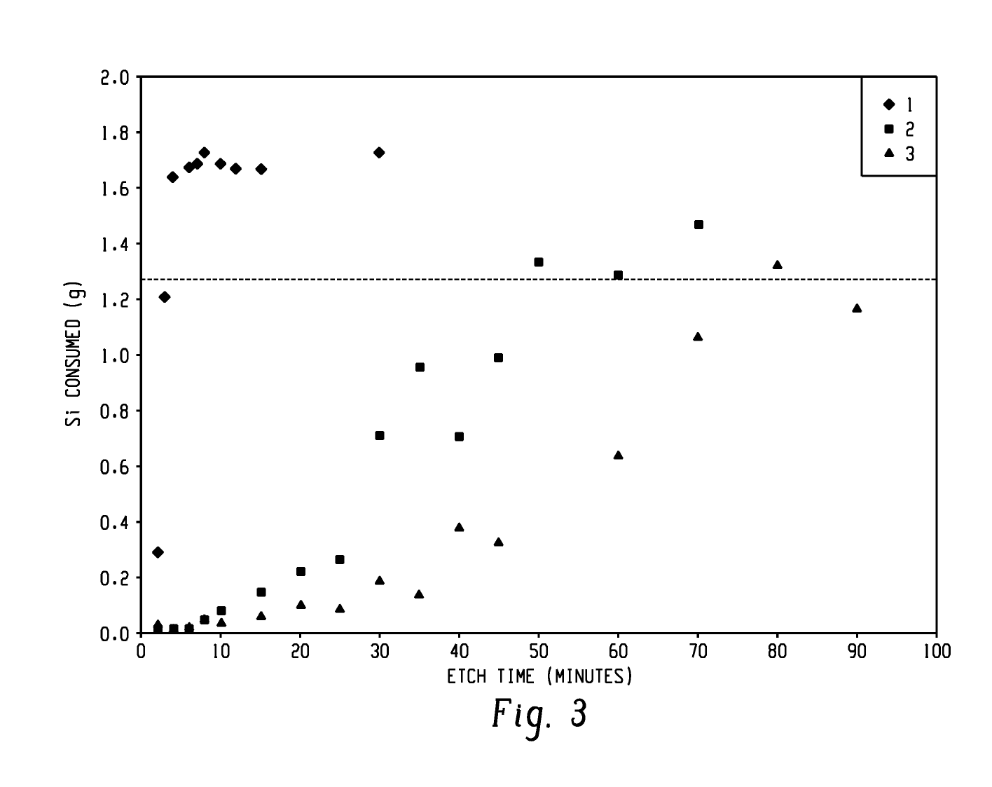

To verify that silicon consumption works as previously calculated herein and identify the amount of time needed for mixture to reach completion, one hundred gram samples of small, medium, and large silicon products were exposed to 100 ml of the etching mixture for various time periods and weight loss tracked over time. Since hydrofluoric acid is the limiting reagent, the etch mixture will exhaust itself and silicon consumption will cease. It can be expected that different surface areas result in different etch completion times; i.e., the largest surface area silicon product should have the shortest etch completion time and the smallest surface area silicon product should have the longest etch completion time. Results confirmed this, showing silicon consumption in the largest surface area silicon product is complete after approximately 6 minutes; total consumption in the medium surface area silicon product is complete after approximately 50 minutes and the total consumption time for the smallest surface area silicon product is complete after greater than 70 minutes. The largest surface area silicon product data demonstrated that the scales measured about 1.7 g consumed. A repeat of the experiment demonstrated the same result. An example of different consumption profiles for small 1, medium 2, and large 3 silicon product material is shown in FIG. 3, where small refers to a size of 0.2 to 18 mm, medium refers to a size of 12 to 65 mm, and large refers to a size of 25-125 mm. In FIG. 3, silicon consumed measured in grams (g) is plotted against etch time measured in minutes.

Ultimately, the combination of results from FIG. 2 (etch greater than 1 gram of silicon) and FIG. 3 (60 minutes to consume >1 gram of silicon) suggest a 60 minute digestion period for the etch mixture can be sufficient for full recovery of surface and sub-surface embedded metals from all product types.

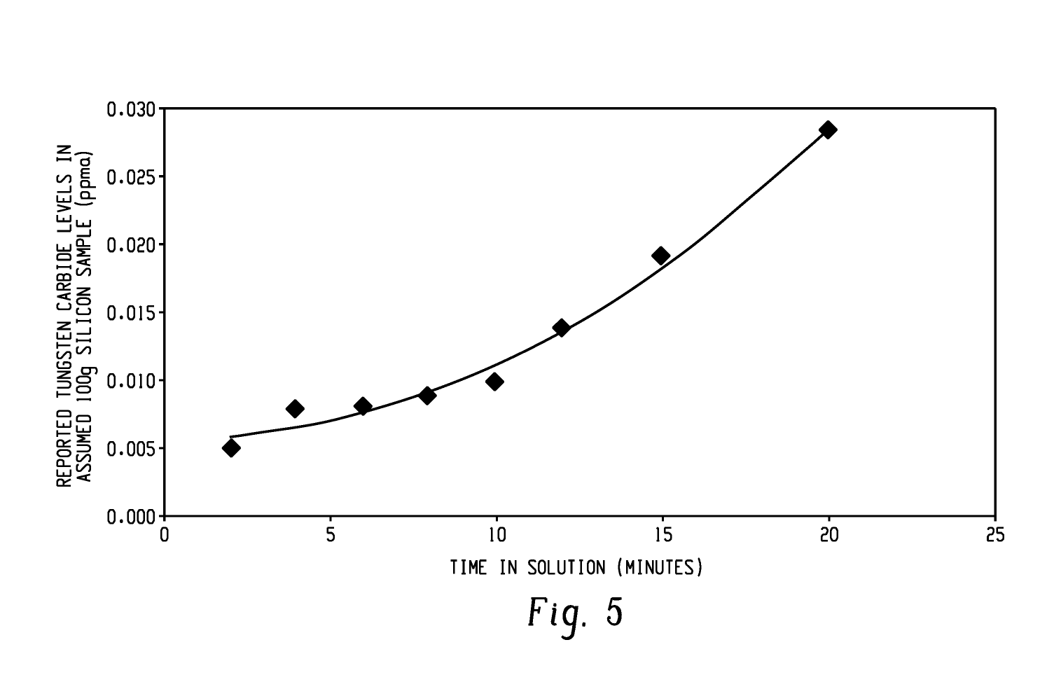

Tungsten dissolution presents a different situation than for other free metals, since the tungsten is assumed to come predominantly from tungsten carbide. The HCl is added to the etch mixture to allow the dissolution of tungsten carbide. FIG. 4 and FIG. 5 illustrate the ability of the etch mixture to identify tungsten by exposing coupons of tungsten carbide to the etch mixture for various time periods and tracking mass consumption. In FIG. 5, the reported tungsten carbide levels in an assumed 100 gram silicon sample measured in ppba is plotted against time in solution measured in minutes.

Doping studies can show that the method disclosed herein with the etch mixture disclosed herein can recover higher amounts of the dissolved tungsten in solution relative to the FRS test method. Even at a twenty minute digestion time with the method disclosed herein, the tungsten carbide can dissolve and be measurable in solution up to about 20 ppma. Since tungsten carbide is expected to be present at levels less than 1 ppm (or 1000 ppb), it should dissolve well before the first hour has elapsed.

After determining the stoichiometry for the etch method disclosed herein, an extensive recovery study comparing VPD, FRS and the new light etch chemistries was conducted. The recovery study was done at four different levels (approximately 5, 20, 40, and 60 parts per trillion atomic (ppta)) to capture percent recoveries for metals of interest in all likely production scenarios. The results are parceled in tabular form in Table 5.

A new surface test was developed to replace both existing surface metal tests (VPD and FRS), which each had noticeable flaws in impurity recovery. The new test can utilize an etch mixture that can quantitatively recover impurities by consistently removing a fixed mass of silicon, empirically determined to be enough etching to remove all surface and sub-surface impregnated metals. This method not only leads to more accurate surface metal test results, but captures sub-surface impurities chronically missed by the VPD and FRS test methods. The creation of a unilateral surface metals test permits data results from intermediate and final product silicon to be easily compared side-by-side, and eliminates widespread confusion in comparing metals results from numerous surface technologies.

### EXAMPLES

### Example 1: Impurity Profile Generation (See FIG. 1)

100 g samples of medium size silicon product containing high surface copper were subjected to six sequential etches lasting 15 seconds, 15 seconds, 30 seconds, 1 minute, 1 minute, 2 minutes and 2 minutes respectively, to give cumulative etch times of 15 seconds, 30 seconds, 1 minute, 2 minutes, 4 minutes and 6 minutes. Etching was completed using an etch mixture of 8 HNO₃:1 HF (v/v). At the elapsed time, the etchant was decanted, dried down, reconstituted to 5 ml and tested via DRC ICP-MS. The remainder of the silicon was completely digested, dried down, reconstituted to 5 ml and tested via DRC ICP-MS. The results indicated sub-surface metal migration.

### Example 2: Silicon Consumption Determination Experiment with Etch Mixture (See FIGS. 3, 4, and 5)

Ten samples of high surface area silicon product (i.e., surface area of 0.2-18 mm), medium surface area silicon product (i.e., surface area of 12-65 mm), and 14 samples of low surface area silicon product (i.e., surface area of 25-125 mm) containing approximately 100 g of silicon each and eight samples of tungsten carbide of 1.5-2.5 g mass were obtained and placed in 240 ml perfluoroalkoxy (PFA) containers.

The ten samples of high surface area silicon product were immersed in 100 ml of etch solution for times of 2, 3, 4, 5, 6, 8, 10, 12, 15 and 30 minutes, after which the liquid was decanted, the silicon dried and the final weight recorded to determine amount of silicon consumed.

The fourteen samples of medium surface area silicon product were immersed in 100 ml of etch solution for times of 2, 4, 6, 8, 10, 15, 20, 25, 30, 35, 40, 45, 50, 60 and 70 minutes, after which the liquid decanted, the silicon dried and the final weight recorded to determine the amount of silicon consumed.

The fourteen samples of low surface area silicon product were immersed in 100 ml of etch solution for times of 2, 4, 6, 8, 10, 15, 20, 25, 30, 35, 40, 45, 60, 70, 80 and 90 minutes, after which the liquid decanted, the silicon dried and the final weight recorded to determine the amount of silicon consumed.

The samples of tungsten carbide were immersed in 100 ml of etch solution for times of 2, 4, 6, 8, 10, 12, 15 and 20 minutes, after which the liquid was decanted and the final weight recorded to determine the amount of tungsten carbide consumed.

### Example 3: Doped Metals Recovery Experiment on Light Etch, VPD, and FRS Chemistries

2700 g of medium surface area size silicon product were obtained where all pieces were pre-selected to have a mass of 18-22 grams and pre-etched the silicon using three rounds of 8 HNO₃:1 HF by volume until the temperature reached 50° C., followed by one 10 minute etch in 20 HNO₃:1 HF by volume. The silicon was then divided into 100 gram samples (27 in total), each in a 240 ml PFA container.

A dopant solution containing Fe, Ni, Cu, Cr, Na, Zn, Mg, Al, Mn, Mo, Ti, W, Co, K, Ca was prepared from instrument calibration standards by adding 243 microliters (ph of the 1 ppm standard to 2700 ml of 2% (v/v) nitric acid. The 27 samples were divided into groups of nine and each set doped as follows:

1-9 50 ml standard+100 ml distilled water

10-18 100 ml standard+50 ml distilled water

19-27 150 ml standard

The samples were subsequently dried; once dry, the doped silicon was allowed to sit for 72 hours. Three samples from each dopant level group were tested comparing the method disclosed herein (LE) with two other surface metal methods (VPD and FRS) and the results compared for metal recovery. The data is in Table 5 measured in units of ppba with the expected level equal to the dopant level.

TABLE 5

| Expected | | | | Expected | | | |
|---|---|---|---|---|---|---|---|
| level | VPD | FRS | LE | level | VPD | FRS | LE |
| Al | | | | Ca | | | |
| 0.012 | 0.010 | 0.013 | 0.014 | 0.016 | 0.016 | 0.018 | 0.021 |
| | 0.006 | 0.013 | 0.018 | | 0.013 | 0.018 | 0.028 |
| | 0.006 | 0.014 | 0.014 | | 0.021 | 0.017 | 0.018 |
| 0.047 | 0.066 | 0.042 | 0.054 | 0.032 | 0.027 | 0.024 | 0.059 |
| | 0.078 | 0.038 | 0.05 | | 0.056 | 0.026 | 0.04 |
| | 0.047 | 0.039 | 0.046 | | 0.024 | 0.031 | 0.035 |
| 0.094 | 0.097 | 0.089 | 0.092 | 0.063 | 0.135 | 0.07 | 0.069 |
| | 0.107 | 0.085 | 0.103 | | 0.059 | 0.075 | 0.086 |
| | 0.093 | 0.089 | 0.131 | | 0.061 | 0.061 | 0.082 |
| 0.141 | 0.125 | 0.117 | 0.15 | 0.095 | 0.081 | 0.09 | 0.114 |
| | 0.139 | 0.126 | 0.144 | | 0.084 | 0.102 | 0.095 |
| | 0.156 | 0.123 | 0.138 | | 0.1 | 0.086 | 0.101 |
| Co | | | | Cr | | | |
| 0.005 | 0.005 | 0.005 | 0.005 | 0.006 | 0.006 | 0.007 | 0.007 |
| | 0.004 | 0.005 | 0.005 | | 0.005 | 0.009 | 0.006 |
| | 0.005 | 0.006 | 0.005 | | 0.005 | 0.007 | 0.007 |
| 0.021 | 0.019 | 0.019 | 0.02 | 0.024 | 0.021 | 0.018 | 0.017 |
| | 0.015 | 0.02 | 0.02 | | 0.019 | 0.02 | 0.017 |
| | 0.021 | 0.021 | 0.018 | | 0.02 | 0.021 | 0.018 |
| 0.043 | 0.039 | 0.042 | 0.04 | 0.048 | 0.041 | 0.041 | 0.036 |
| | 0.039 | 0.04 | 0.043 | | 0.046 | 0.04 | 0.042 |
| | 0.04 | 0.041 | 0.042 | | 0.043 | 0.042 | 0.045 |
| 0.064 | 0.055 | 0.058 | 0.065 | 0.073 | 0.062 | 0.06 | 0.062 |
| | 0.058 | 0.061 | 0.063 | | 0.065 | 0.061 | 0.065 |
| | 0.057 | 0.059 | 0.06 | | 0.062 | 0.059 | 0.065 |
| Cu | | | | Fe | | | |
| 0.005 | 0.002 | 0.005 | 0.005 | 0.011 | 0.020 | 0.011 | 0.013 |
| | 0.002 | 0.006 | 0.006 | | 0.009 | 0.010 | 0.014 |
| | 0.002 | 0.006 | 0.005 | | 0.018 | 0.015 | 0.017 |
| 0.020 | 0.008 | 0.016 | 0.018 | 0.022 | 0.018 | 0.015 | 0.022 |
| | 0.007 | 0.017 | 0.019 | | 0.017 | 0.018 | 0.02 |
| | 0.009 | 0.017 | 0.017 | | 0.018 | 0.02 | 0.019 |
| 0.040 | 0.02 | 0.036 | 0.035 | 0.044 | 0.04 | 0.044 | 0.039 |
| | 0.023 | 0.035 | 0.037 | | 0.038 | 0.04 | 0.044 |
| | 0.018 | 0.035 | 0.037 | | 0.036 | 0.039 | 0.05 |
| 0.060 | 0.026 | 0.05 | 0.059 | 0.066 | 0.056 | 0.056 | 0.068 |
| | 0.038 | 0.053 | 0.054 | | 0.058 | 0.059 | 0.061 |
| | 0.03 | 0.052 | 0.054 | | 0.057 | 0.058 | 0.064 |
| Mg | | | | Mn | | | |
| 0.013 | 0.014 | 0.014 | 0.014 | 0.006 | 0.005 | 0.005 | 0.006 |
| | 0.013 | 0.016 | 0.013 | | 0.005 | 0.005 | 0.006 |
| | 0.013 | 0.015 | 0.012 | | 0.005 | 0.006 | 0.005 |
| 0.052 | 0.046 | 0.045 | 0.051 | 0.023 | 0.02 | 0.019 | 0.022 |
| | 0.085 | 0.048 | 0.053 | | 0.019 | 0.022 | 0.023 |
| | 0.047 | 0.047 | 0.05 | | 0.02 | 0.023 | 0.021 |
| 0.104 | 0.094 | 0.098 | 0.095 | 0.046 | 0.044 | 0.045 | 0.042 |
| | 0.092 | 0.091 | 0.103 | | 0.043 | 0.042 | 0.048 |
| | 0.094 | 0.094 | 0.099 | | 0.041 | 0.044 | 0.047 |
| 0.156 | 0.144 | 0.133 | 0.164 | 0.069 | 0.061 | 0.063 | 0.072 |
| | 0.144 | 0.144 | 0.147 | | 0.065 | 0.067 | 0.065 |
| | 0.134 | 0.141 | 0.151 | | 0.061 | 0.064 | 0.067 |
| Mo | | | | Ni | | | |
| 0.003 | 0.015 | 0.002 | 0.004 | 0.005 | 0.004 | 0.005 | 0.007 |
| | 0.001 | 0.002 | 0.004 | | 0.005 | 0.004 | 0.006 |
| | −0.002 | 0.003 | 0.003 | | 0.006 | 0.004 | 0.006 |
| 0.013 | 0.011 | 0.011 | 0.012 | 0.021 | 0.021 | 0.018 | 0.02 |
| | 0.009 | 0.012 | 0.012 | | 0.013 | 0.019 | 0.025 |
| | 0.012 | 0.011 | 0.012 | | 0.015 | 0.02 | 0.02 |
| 0.026 | 0.022 | 0.025 | 0.024 | 0.042 | 0.034 | 0.042 | 0.04 |
| | 0.022 | 0.022 | 0.025 | | 0.034 | 0.037 | 0.042 |
| | 0.022 | 0.023 | 0.025 | | 0.032 | 0.039 | 0.045 |
| 0.040 | 0.032 | 0.033 | 0.039 | 0.063 | 0.046 | 0.055 | 0.068 |
| | 0.035 | 0.037 | 0.039 | | 0.041 | 0.057 | 0.076 |
| | 0.033 | 0.035 | 0.037 | | 0.05 | 0.056 | 0.067 |
| K | | | | Na | | | |
| 0.008 | 0.008 | 0.010 | 0.009 | 0.014 | 0.012 | 0.020 | 0.012 |
| | 0.008 | 0.008 | 0.010 | | 0.012 | 0.016 | 0.013 |
| | 0.008 | 0.009 | 0.008 | | 0.013 | 0.015 | 0.013 |
| 0.032 | 0.029 | 0.028 | 0.032 | 0.049 | 0.05 | 0.047 | 0.058 |
| | 0.026 | 0.028 | 0.032 | | 0.05 | 0.051 | 0.058 |
| | 0.028 | 0.031 | 0.03 | | 0.049 | 0.052 | 0.055 |
| 0.065 | 0.061 | 0.062 | 0.061 | 0.098 | 0.105 | 0.109 | 0.104 |
| | 0.06 | 0.058 | 0.069 | | 0.107 | 0.099 | 0.112 |
| | 0.06 | 0.062 | 0.066 | | 0.101 | 0.103 | 0.108 |
| 0.097 | 0.082 | 0.087 | 0.101 | 0.147 | 0.142 | 0.149 | 0.172 |
| | 0.09 | 0.091 | 0.092 | | 0.15 | 0.156 | 0.158 |
| | 0.087 | 0.086 | 0.096 | | 0.144 | 0.156 | 0.163 |
| Ti | | | | W | | | |
| 0.007 | 0.006 | 0.007 | 0.011 | 0.002 | 0.001 | 0.002 | 0.002 |
| | 0.004 | 0.009 | 0.008 | | 0.001 | 0.001 | 0.002 |
| | 0.007 | 0.008 | 0.011 | | 0.001 | 0.002 | 0.002 |
| 0.026 | 0.042 | 0.022 | 0.026 | 0.007 | 0.005 | 0.005 | 0.006 |
| | 0.038 | 0.021 | 0.02 | | 0.005 | 0.005 | 0.007 |
| | 0.031 | 0.025 | 0.024 | | 0.005 | 0.005 | 0.006 |
| 0.053 | 0.051 | 0.047 | 0.045 | 0.014 | 0.011 | 0.009 | 0.011 |
| | 0.054 | 0.048 | 0.05 | | 0.008 | 0.008 | 0.012 |
| | 0.05 | 0.045 | 0.065 | | 0.011 | 0.008 | 0.013 |
| 0.079 | 0.076 | 0.06 | 0.076 | 0.021 | 0.015 | 0.008 | 0.018 |
| | 0.075 | 0.063 | 0.069 | | 0.016 | 0.009 | 0.017 |
| | 0.075 | 0.064 | 0.07 | | 0.016 | 0.015 | 0.017 |

Zn

| Expected level | VPD | FRS | LE |
|---|---|---|---|
| 0.010 | 0.009 | 0.006 | 0.008 |
| | 0.009 | 0.006 | 0.014 |
| | 0.013 | 0.007 | 0.008 |
| 0.019 | 0.011 | 0.009 | 0.021 |
| | 0.011 | 0.011 | 0.022 |
| | 0.013 | 0.01 | 0.014 |
| 0.038 | 0.062 | 0.033 | 0.031 |
| | 0.026 | 0.026 | 0.047 |
| | 0.027 | 0.027 | 0.029 |
| 0.057 | 0.041 | 0.04 | 0.044 |
| | 0.041 | 0.054 | 0.062 |
| | 0.04 | 0.044 | 0.042 |

### Ppba & MDL Calculations:

Calculation of the silicon surface metals impurity results into units of ppba is as follows:
ppba=(ppbw sample−ppbw blank)*5/SW*28.09/MWₑ
where ppbw sample=sample result from ICP-MS
ppbw blank=acid blank result from ICP-MS
5=final sample volume
SW=sample weight in g
MWₑ=molecular weight of element
   Calculation of method detection limits from the acid blank data was completed as follows:
MDL=stdev*t-value at 99% conf. level for n−1 degrees of freedom MDL values were converted to ppba by using the above equation, assuming a 100 g sample weight and ignoring the blank subtraction term.

The methods disclosed herein include at least the following embodiments:

### Embodiment 1

A method of quantifying metal impurities on a silicon product, comprising: obtaining a sample of the silicon product; etching or chemically treating a surface of silicon product to retrieve a predetermined amount of silicon product mass; and testing and measuring the etched portion for the presence of metal impurities using a testing measurement technique selected from ICP-MS, ICP-OES, IC, or a combination comprising at least one of the foregoing, wherein the metal impurities are selected from sodium, magnesium, nickel, copper, zinc, molybdenum, tungsten, aluminum, potassium, calcium, titanium, chromium, manganese, iron, cobalt, or a combination comprising at least one of the foregoing.

### Embodiment 2

A method of quantifying metal impurities on silicon products, comprising: obtaining a sample of a silicon product; removing 1.0% to 2.0% sample mass of the silicon product to obtain an etched portion of the silicon product; and testing and measuring the etched portion for the presence of metal impurities using a testing measurement technique selected from ICP-MS, ICP-OES, IC, or a combination comprising at least one of the foregoing, wherein the metal impurities are selected from sodium, magnesium, nickel, copper, zinc, molybdenum, tungsten, aluminum, potassium, calcium, titanium, chromium, manganese, iron, cobalt, or a combination comprising at least one of the foregoing.

### Embodiment 3

The method of claim 1 or claim 2, further comprising testing for other metal impurities having the capability of dissolving within acidic media.

### Embodiment 4

The method of any of claims 1-3, wherein the silicon product comprises a polycrystalline silicon product.

### Embodiment 5

The method of any of claims 1-4, wherein the sample of the silicon product comprises silicon particles having a size of 0.05 millimeters on a side to 500 millimeters on a side.

### Embodiment 6

The method of claim 5, wherein the sample of the silicon product comprises silicon particles having a size of 0.2 millimeters on a side to 125 millimeters on a side.

### Embodiment 7

The method of any of claims 1-6, wherein a geometric-shape of the silicon product being evaluated may include cube, cuboid, cylinder, sphere, triangular prism, cone, hexagonal prism, pentagonal prism, square pyramid, triangular pyramid, hexagonal pyramid, parallelepiped, tetrahedron, octahedron, dodecahedron, icosahedron, rhombic dodecahedron, frustum, or a combination comprising at least one of the foregoing.

### Embodiment 8

The method of any of claims 1-7, further comprising monitoring diffusion of metals from the surface of the silicon product into a sub-surface of the silicon product within 72 hours of submitting the silicon product for analysis.

### Embodiment 9

The method of any of claims 1-8, further comprising reporting metal impurities values as a total metal impurity content for the silicon product.

### Embodiment 10

The method of any of claims 1-9, further comprising reporting metals impurity values as a total metal impurity content for the silicon product through combination of this method with suitable bulk metal impurity measurements. Several examples are NAA, GDMS, bulk metals tip process, or Trace Metals Analysis in Semiconductor Material.

### Embodiment 11

The method of any of claims 1-10, further comprising reporting metal impurities values as surface metal impurity values and bulk metal impurity values.

### Embodiment 12

The method of any of claims 1-11, wherein the measurement technique allows measurement and analysis of silicon product samples having varying product types, sizes, and geometric shapes.

### Embodiment 13

The method of any of claims 1-12, further comprising measuring the total metal impurities from 1 part metal impurities per trillion atoms of silicon to 1,000 parts metal impurities per billion atoms of silicon.

### Embodiment 14

The method of any of claims 1-13, wherein the silicon product has a weight of greater than or equal to 1 gram.

### Embodiment 15

The method of any of claims 1-14, wherein the etching lasts for greater than or equal to 6 minutes.

The singular forms “a,” “an,” and “the” include plural referents unless the context clearly dictates otherwise. “Or” means “and/or.” The modifier “about” used in connection with a quantity is inclusive of the stated value and has the meaning dictated by the context (e.g., includes the degree of error associated with measurement of the particular quantity). The notation “±10%” means that the indicated measurement can be from an amount that is minus 10% to an amount that is plus 10% of the stated value. The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group.

The suffix “(s)” is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. Unless defined otherwise, technical and scientific terms used herein have the same meaning as is commonly understood by one of skill in the art to which this invention belongs. A “combination” is inclusive of blends, mixtures, alloys, reaction products, and the like.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

What is claimed is:

1. A method of quantifying metal impurities on a silicon product, comprising:
obtaining a sample of the silicon product;
etching or chemically treating a surface of silicon product to retrieve a predetermined amount of silicon product mass; and
testing and measuring the etched portion for the presence of metal impurities using a testing measurement technique selected from ICP-MS, ICP-OES, IC, or a combination comprising at least one of the foregoing, wherein the metal impurities are selected from sodium, magnesium, nickel, copper, zinc, molybdenum, tungsten, aluminum, potassium, calcium, titanium, chromium, manganese, iron, cobalt, or a combination comprising at least one of the foregoing.

2. The method of claim 1, further comprising testing for other metal impurities having the capability of dissolving within acidic media.

3. The method of claim 1, wherein the silicon product comprises a polycrystalline silicon product.

4. The method of claim 1, wherein the sample of the silicon product comprises silicon particles having a size of 0.05 millimeters on a side to 500 millimeters on a side.

5. The method of claim 5, wherein the sample of the silicon product comprises silicon particles having a size of 0.2 millimeters on a side to 125 millimeters on a side.

6. The method of claim 1, wherein a geometric-shape of the silicon product being evaluated includes cube, cuboid, cylinder, sphere, triangular prism, cone, hexagonal prism, pentagonal prism, square pyramid, triangular pyramid, hexagonal pyramid, parallelepiped, tetrahedron, octahedron, dodecahedron, icosahedron, rhombic dodecahedron, frustum, or a combination comprising at least one of the foregoing.

7. The method of claim 1, further comprising monitoring diffusion of metals from the surface of the silicon product into a sub-surface of the silicon product within 72 hours of submitting the silicon product for analysis.

8. The method of claim 1, further comprising reporting metal impurities values as a total metal impurity content for the silicon product.

9. The method of claim 1, further comprising reporting metals impurity values as a total metal impurity content for the silicon product through combination of this method with suitable bulk metal impurity measurements.

10. The method of claim 1, further comprising reporting metal impurities values as surface metal impurity values and bulk metal impurity values.

11. The method of claim 1, wherein the measurement technique allows measurement and analysis of silicon product samples having varying product types, sizes, and geometric shapes.

12. The method of claim 1, further comprising measuring the total metal impurities from 1 part metal impurities per trillion atoms of silicon to 1,000 parts metal impurities per billion atoms of silicon.

13. The method of claim 1, wherein the silicon product has a weight of greater than or equal to 1 gram.

14. The method of claim 1, wherein the etching lasts for greater than or equal to 6 minutes.

15. A method of quantifying metal impurities on silicon products, comprising:
obtaining a sample of a silicon product;
removing 1.0% to 2.0% sample mass of the silicon product to obtain an etched portion of the silicon product; and
testing and measuring the etched portion for the presence of metal impurities using a testing measurement technique selected from ICP-MS, ICP-OES, IC, or a combination comprising at least one of the foregoing, wherein the metal impurities are selected from sodium, magnesium, nickel, copper, zinc, molybdenum, tungsten, aluminum, potassium, calcium, titanium, chromium, manganese, iron, cobalt, or a combination comprising at least one of the foregoing.

16. The method of claim 15, further comprising monitoring diffusion of metals from the surface of the silicon product into a sub-surface of the silicon product within 72 hours of submitting the silicon product for analysis

17. The method of claim 15, wherein the measurement technique allows measurement and analysis of silicon product samples having varying product types, sizes, and geometric shapes.

18. The method of claim 15, further comprising measuring the total metal impurities from 1 part metal impurities per trillion atoms of silicon to 1,000 parts metal impurities per billion atoms of silicon.

19. The method of claim 15, wherein the silicon product has a weight of greater than or equal to 1 gram.

20. The method of claim 15, wherein the etching lasts for greater than or equal to 6 minutes.
